(19) United States
(12) Patent Application Publication
(10) Pub. No.: US 2014/0128994 A1
(43) Pub. Date: May 8, 2014

(54) LOGICAL SENSOR SERVER FOR LOGICAL SENSOR PLATFORMS

(71) Applicant: MICROSOFT CORPORATION, Redmond, WA (US)

(72) Inventors: Kimberly Denise Auyang Hallman, Bellevue, WA (US); Desney Tan, Kirkland, WA (US); Ira Snyder, Bellevue, WA (US); Mats Myrberg, Seattle, WA (US); Michael Hall, Snohomish, WA (US); Michael Koenig, Bellevue, WA (US); Andrew Wilson, Seattle, WA (US); Grigor Shirakyan, Kirkland, WA (US); Matthew Dyor, Bellevue, WA (US)

(73) Assignee: MICROSOFT CORPORATION, Redmond, WA (US)

(21) Appl. No.: 13/670,633

(22) Filed: Nov. 7, 2012

(51) Int. Cl. G05B 11/01

(52) U.S. Cl. 700/12

(57) ABSTRACT

A “Logical Sensor Server” or “LSS” acts as a smart hub between related or unrelated sensors, devices, or other systems by translating, morphing, or forwarding signals or events published by various input sources into signals or higher-order events that can be consumed or used by other subscribing sensors, devices, or systems. More specifically, the LSS acts alone or in combination with a Logical Sensor Platform (LSP) to enable various techniques that allow messages received from different input sources to be authored, transformed and made available to one or more subscribers in a manner that allows intelligent event-driven behavior to emerge from a collection of relatively simple input sources. Any combination of automatic configuration or user input is used to define the format of transformed inputs to be received by particular subscribers relative to one or more publications. Subscribers receiving transformed events control their own actions based on those events.

### BACKGROUND

Technology is often insensitive to circumstances that may appear trivial to a person. For example, office lighting controlled by a timer may turn off the lights in the evening even if there are still people on the floor. Similarly, motion detection sensor-based systems may turn off lights when people are stationary at their desks. Unfortunately, installing multiple independent types of sensors and combining their input may complicate and increase the cost of the overall system.

One of the challenges in developing technology that interacts with humans is making that technology intelligently sensitive to complex environments. In general, intelligent sensitivity typically depends upon aggregated analysis of rich information from the physical world collected by a multitude of sensors such as cameras, thermometers, motion sensors, etc. This analysis is typically a complex task, because even simple decisions (e.g., keeping lights on while there are people on a particular floor of a building) may require input from a large number of different types of sensors (as well as logical context, such as a calendar or clock).

Many simple systems make use of basic sensors to act on the input provided by those sensors to initiate some sort of pre-programmed action. For example, a typical thermostat may receive a temperature reading from a tightly coupled temperature sensor and, based on that reading, will cause a heating or cooling system to be turned on or otherwise adjusted. Unfortunately, the temperature sensor in the thermostat is generally dedicated or integral to the thermostat, so that temperature information from that sensor is generally not available for other uses. Consequently, other systems that might also make use of the temperature, such as an automated system that closes window coverings on hot and sunny days, will typically use their own dedicated sensors or manual switches for control purposes.

Similarly, in the case of software-based processing of sensor inputs, many such systems operate based on a tight coupling between one or more particular sensors and one or more software-based systems that process the sensor data and then initiate some corresponding action. For example, a typical home security system triggers an alarm (and possibly automated calls to a security service and/or 911) in response to triggering of one or more installed motion sensors when the alarm system is in an armed state. These types of solutions often depend on a network of dedicated sensors. Such networks can often be extended by adding additional compatible sensors of known types (e.g., compatible door contact sensors, security cameras, microwave or infrared motion sensors, etc.).

Unfortunately, extending such sensor networks is usually limited to adding compatible sensors or devices because purpose built systems, such as, for example, home security systems, cannot generally accommodate alternative sources of logical information that could be provided by other sensors or devices. Consequently, where multiple different systems are operating within the same general area, such systems often use a plurality of otherwise duplicative sensors to provide inputs in formats that are specific to their corresponding system. For example, one motion sensor coupled to a motion-activated light switch may be used in the same room as a motion sensor dedicated to an unrelated local security system. However, neither the light switch nor the security system makes use of the motion sensor associated with the other system.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of prior technologies may be noted or discussed herein, the claimed subject matter is not intended to be limited to implementations that may solve or address any or all of the disadvantages of those prior technologies.

In general, a “Logical Sensor Server” (LSS), as described herein, acts as a smart hub between unrelated sensors or other devices by translating, morphing or forwarding signals or events published by a wide variety of input sources into signals or events that can be consumed or used by other sensors, devices, or systems. In other words, the LSS receives inputs from various sources, translates or transforms those inputs into various formats, and then provides the translated or transformed inputs, or events corresponding to those inputs, to one or more other unrelated sensors, agents, devices, systems, etc. This enables the unrelated sensors, agents, devices, systems, etc., to make use of inputs provided by other input sources.

With respect to the architecture of the LSS, the general idea is that various related or unrelated input sources publish their input or events to the LSS. For example, such inputs include, but are not limited to, sensor readings such as temperature, motion detected, etc., “events” such as ‘air conditioner turned on’, ‘television turned on’, ‘on’ button pressed on remote control device, etc., infrastructure events such as ‘elevator button press’ or ‘light switched off’, etc. The LSS then transforms that input to various formats compatible with subscribing devices, agents, etc., and provides that transformed input to the subscribers. The subscribers receiving that transformed input can then act on that input without requiring further input or higher-level control from the LSS.

A simple example of this concept is the LSS receiving an input from a coffee maker indicating that it has been turned on to brew coffee (i.e., LSS receives a publication from the coffee maker indicating that it's ‘on’ button has been pressed). The LSS then transforms this publication for use by other devices, agents, or systems. For example, a simple transformation of the ‘on’ button being pressed includes, but is not limited to, a ‘people present’ event or the like. Providing a ‘people present’ event (in a format usable by other devices or systems) can then be used for a variety of purposes such as, for example, an automated light switch that will turn on the lights when people are present. In this case, the automated light switch will receive a person present type of event from the LSS. The light switch can then cycle the lights in response.

Note that the light switch in the above example does not need to be capable of complex processing. For example, the LSS can simply provide a logical one or zero (or some other analog or digital signal or indication) to the light switch to indicate ‘on’ or ‘off’ to the light switch. In this case, the light switch simply subscribes to the LSS to receive events that originate from any one or more input sources indicating that people are present. Such events are provided to the light switch by the LSS in whatever format is useful to the light switch.

Further, the LSS provides a mechanism wherein the output or publications of existing sensors or input devices is processed to enable the creation of new “logical sensors,” thereby enabling the initiation of actions not normally associated with the output or publications of various sensors or input sources. For example, assume that there is no motion sensor in a user's home or that an existing motion sensor is offline for some reason (e.g., the battery for that sensor is dead). In response, the LSS can ‘synthesize’ a logical motion sensor based on one or more of a wide range of publications from various input sources. For example, either or both a publication indicating usage of TV remote control or a publication indicating a toilet flush inferred from flow rates through a water meter can be transformed into a “person in house” type output event that is then provided to one or more subscribers for further action.

In view of the above summary, it is clear that the LSS described herein provides various techniques that allow messages received from different input sources to be authored, transformed and made available to one or more subscribers in a manner that allows intelligent event-driven behavior to emerge from a collection of relatively simple unrelated input sources. In addition to the just described benefits, other advantages of the LSS will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 illustrates a general architectural diagram in which arbitrary input sources publish inputs or events to a “Logical Sensor Server” (LSS) which then translates those publications to formats or other events that can be consumed by other devices or systems subscribed to receive the translated information, as described herein.

FIG. 2 provides an exemplary flow diagram that illustrates program modules for implementing various embodiments of the LSS, as described herein.

FIG. 3 illustrates an exemplary user interface for use with various embodiments of the LSS, as described herein

FIG. 4 illustrates a general system flow diagram that illustrates exemplary methods for implementing various embodiments of the LSS, as described herein.

FIG. 5 is a general system diagram depicting a simplified general-purpose computing device having simplified computing and I/O capabilities for use in implementing various embodiments of the LSS, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

For purposes of explanation, the terms “input source” or “publisher” in the following discussion are specifically defined as a device that detects or measures physical phenomena and quantities and transforms those into convenient electrical, radio frequency, audio or optical signals, that are then published as inputs or events to a “Logical Sensor Server” (LSS). Examples of input sources include, but are not limited to a wide variety of devices, sensors, voice input mechanisms, gesture or touch-based input mechanisms, software agents, software events, infrastructure events, etc. In addition, a “logical sensor” is defined as a “software agent” that embodies a sensor or other input source. Note that publication translation, transformation and/or propagation actions performed by the LSS are provided by an “event translation service” component of the LSS. Further, the term “subscriber” in the following discussion is specifically defined as referring to a wide variety of devices, sensors, software agents, other LSS's, etc., that receive higher-order events from the LSS that have been translated or transformed from the publications of one or more input sources.

In general, the LSS acts as a form of smart hub between related or unrelated sensors, devices, or other systems by translating, morphing, or forwarding signals or events published by a wide variety of input sources into signals or higher-order events that can be consumed or used by other sensors, devices, or systems. More specifically, the LSS acts alone or in combination with a Logical Sensor Platform (LSP) to enable various techniques that allow messages received from different input sources to be authored, transformed and made available to one or more subscribers in a manner that allows intelligent event-driven behavior to emerge from a collection of relatively simple input sources.

Advantageously, these capabilities provide a hardware-agnostic platform for publishing and subscribing to higher-order events that allows the LSS to help existing systems to evolve over time by adding a layer of intelligent sensitivity to such systems without requiring those systems to be changed. Also advantageously, this means that the LSS itself does not require the complexity needed to control any of the subscribing devices, agents, etc., since it simply provides the transformed events in a format that allows those subscribers to use their own control mechanisms to act on those transformed events.

In other words, the LSS contains logic that determines event transformation and propagation relative to publishers and subscribers without requiring the LSS to contain logic for actually controlling any of the publishers or the subscribers. For example, in various embodiments, the LSS is configured to generate or trigger higher-order events such as ‘people detected on the floor’ and ‘people detected in the building’ when a ‘motion detected’ signal or event is received as a publication from a motion detection sensor. Various subscribers, such as floor and building light control systems may also be subscribed to ‘people detected on the floor’ and ‘people detected in the building’ events. Those subscribed systems are then notified with the ‘people detected on the floor’ and ‘people detected in the building’ events are generated by the LSS in response to the ‘motion detected’ signal or event provided to the LSS by the publisher (i.e., the motion detection sensor). In response, the floor and building light control systems can actuate the desired responses (e.g., automatically respond to the output event by turning on the lights because people are present).

Note also that multiple subscribers can all receive the same transformed inputs (in whatever format is useable to each particular subscriber) so that those devices, systems, or agents can individually respond to the transformed inputs in whatever way is desired. Further, software agents or other systems can cause multiple devices to respond to transformed inputs or events provided by the LSS in response to publications received from one or more related or unrelated input sources.

For example, assuming that the LSS receives a publication indicating that person has turned on a television (e.g., TV remote power button pressed, television begins to draw current indicating a powered-on state, etc.), that input can be transformed and provided to a software agent or other system as a higher-order event, e.g., a ‘person watching television’ type event. In response, the software agent or other system then responds by initiating or actuating commands such as, for example, concurrently controlling unrelated automatic systems for dimming the lights, closing the blinds, starting a popcorn popper, sending phone calls to voice mail, etc. Note also that each of these unrelated automatic systems could be individually subscribed to the ‘person watching television’ type event and initiate their own actions in response to receipt of such an event from the LSS.

Further, because the LSS translates, morphs, or forwards signals or events published by a wide variety of input sources into signals or higher-order events that can be consumed or used by other sensors, devices, or systems, the LSS becomes a central location where new control systems, either with or without sensors of their own, can be registered as subscribers. For example, an alarm control system without any motion sensors of its own can be simply subscribed to the LSS to receive publications indicating motion events derived from any of a wide range of input sources. This would allow the alarm control system to trigger an alarm based on inputs such as a TV remote control press publication that was transformed into a “person in house” type event.

In other words, new control systems for any of a wide range of applications can subscribe to the LSS while making use of existing sensor infrastructures (physical and/or logical) and corresponding output events generated by the LSS. Consequently, by subscribing to the LSS, the costs and efforts for installing many types of control systems can be dramatically reduced by limiting, or even eliminating, the traditional sensing devices that are specifically dedicated to such control systems. As such, new control systems for virtually any desired purpose can be installed and controlled by simply subscribing to one or more of the output events available from the LSS.

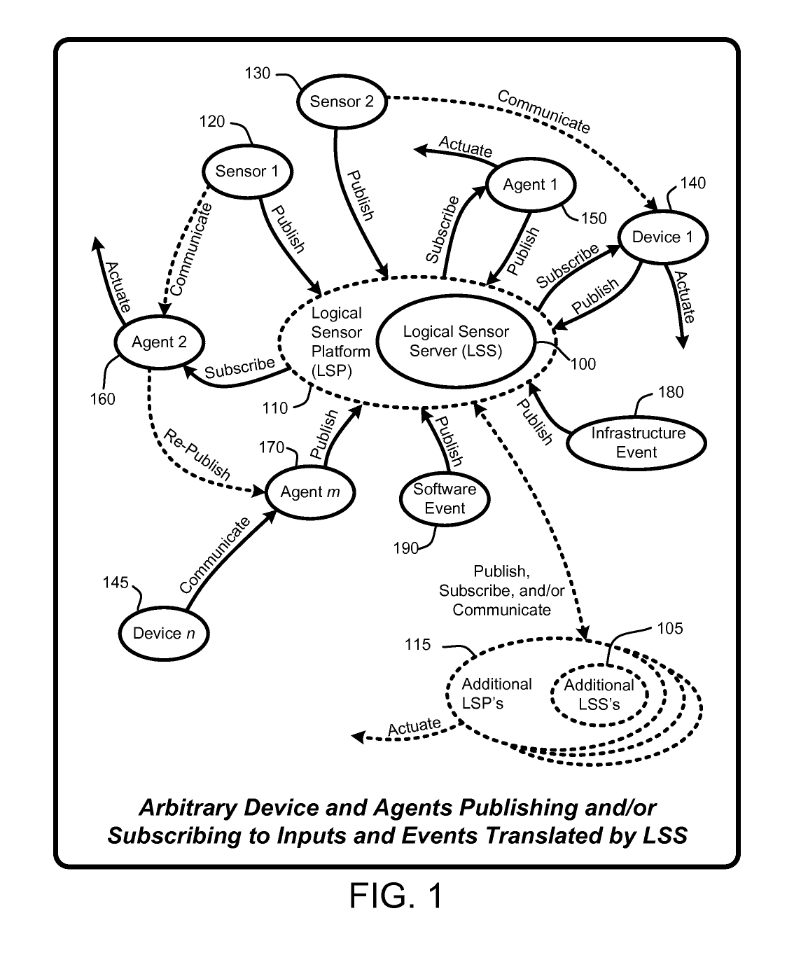

The concepts discussed above are generally illustrated by FIG. 1 which provides a general architectural diagram in which arbitrary input sources publish inputs or events to the LSS which in turn translates those publications to formats or other events that is then consumed by other devices or systems subscribed to receive the translated information.

In particular, FIG. 1 shows an LSS 100, optionally acting as a component within an LSP 110 (see discussion in Section 2.8). The LSS receives publications from any number of arbitrary sensors (e.g., 120, 130), devices (e.g., 140), hardware or software agents (e.g., 150, 170), infrastructure events 180, software events 190, other LSS's 105, other LSP's 115, etc.

In response, the LSS 100 transforms the received publications into higher-order events or formats usable by various subscribers, such as, for example, devices (e.g., 140) agents (e.g., 150, 160), other LSS's 105, other LSP's 115, etc. Note that some of the devices and agents (e.g., “device 1” 140 and “agent 1” 150) act as both publishers and subscribers. Further, agents (e.g., “agent 2” 160) or other devices or systems subscribed to the LSS 100 can re-publish information received via subscription to other agents (e.g., “agent m” 170) or other devices or systems.

Further, various devices, agents, systems, etc., communicate information directly to agents, devices, or other systems. Examples illustrated by FIG. 1 include “agent m” 170 that acts as an intermediary to publish information communicated by “device n” to the LSS 100. In addition, as illustrated by FIG. 1, various sensors (e.g., sensors 120 and 130) may communicate information to other devices, agents, etc. (e.g., “device 1” 140 and “agent 2” 160).

Finally, individual subscribing devices (e.g., “device 1” 140), agents (e.g., agents 150 and 160), other LSS's 105, other LSP's 115, etc., actuate or initiate various actions in response to translated inputs or higher-order events received from the LSS 100 in response to the subscriptions of those devices, agents, etc.

1.1 System Overview:

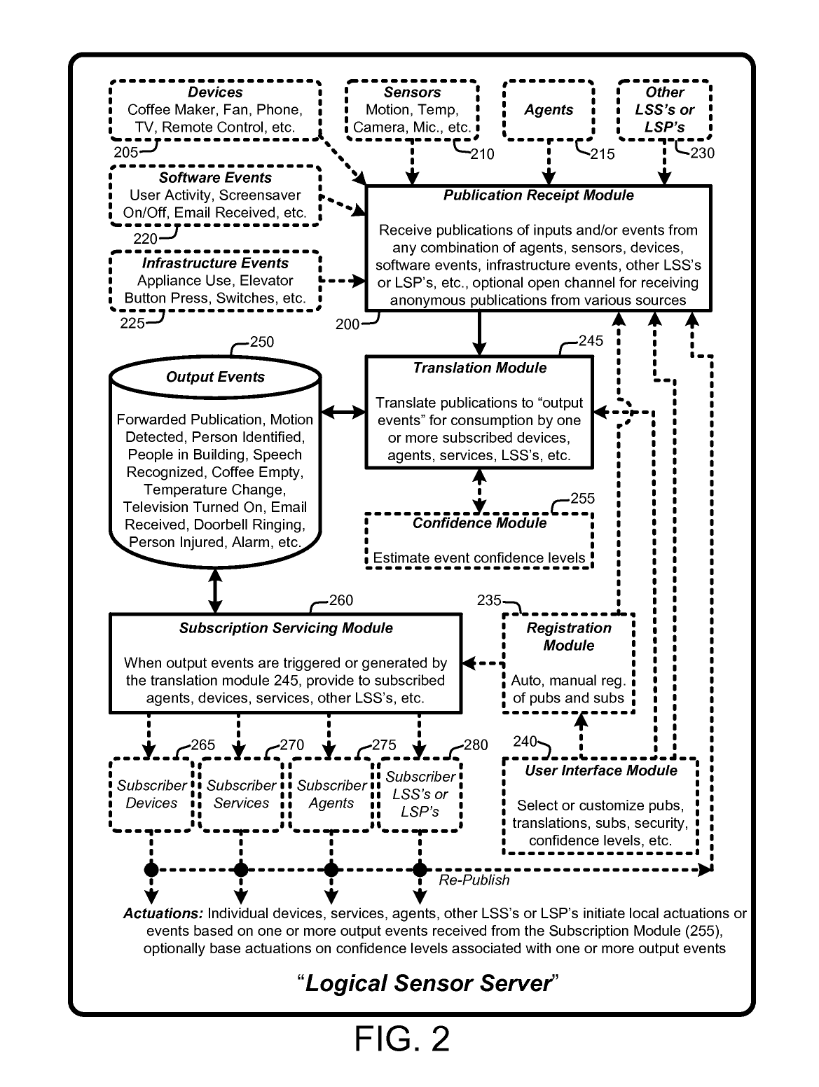

As noted above, the LSS provides various techniques that allow messages received from different input sources to be authored, transformed and made available to one or more subscribers in a manner that allows intelligent event-driven behavior to emerge from a collection of relatively simple related or unrelated input sources. The processes summarized above are illustrated by the general system diagram of FIG. 2. In particular, the system diagram of FIG. 2 illustrates the interrelationships between program modules for implementing various embodiments of the LSS, as described herein. Furthermore, while the system diagram of FIG. 2 illustrates a high-level view of various embodiments of the LSS, FIG. 2 is not intended to provide an exhaustive or complete illustration of every possible embodiment of the LSS as described throughout this document.

In addition, it should be noted that any boxes and interconnections between boxes that may be represented by broken or dashed lines in FIG. 2 represent alternate embodiments of the LSS described herein, and that any or all of these alternate embodiments, as described below, may be used in combination with other alternate embodiments that are described throughout this document.

In general, as illustrated by FIG. 2, the processes enabled by the LSS begin operation by using a publication receipt module 200 to receive publications of inputs and/or events from any combination of “input sources” including devices 205, sensors 210, agents 215, software events 220, infrastructure events 225, other LSS's or LSP's (230), etc. In addition, the publication receipt module 200 optionally includes an open channel or other input means for receiving anonymous publications from various sources. Note that as discussed in Section 2.5, various security precautions may be implemented when dealing with publications from anonymous sources.

An optional registration module 235 is used for registration of “input sources” including devices 205, sensors 210, agents 215, software events 220, infrastructure events 225, other LSS's or LSP's (230), etc. In general, the registration module 235 performs manual and/or automatic registration of publications of input sources and registrations of “subscribers”, including subscriber devices 265, subscriber services 270, subscriber agents 275, subscriber LSS's or LSP's 280, etc., for receiving transformed events. An optional user interface module 240 is used in combination with the publication receipt module 200, the registration module 235, and a translation module 245 to select or customize publications, translations, subscriptions, set security or access levels for various publications or subscriptions, set or adjust confidence levels for events or translations, etc.

The translation module 245 is used to translate publications into “output events” 250 or information formatted for consumption by one or more subscribers (e.g., subscriber devices 265, subscriber services 270, subscriber agents 275, subscriber LSS's or LSP's 280, etc.). Further, in various embodiments, a confidence module is used to set or adjust thresholds or confidence levels for probability-based translations based on publications from sensors or events that offer signal confidence levels. Note that multiple publications having different confidence levels may also be combined to generate or trigger outputs having confidence levels. Such levels can then be used by subscribers in deciding whether to actuate or initiate particular actions.

Whenever a subscribed output event 250 or other information (e.g., forwarded publications such as specific temperature readings, video feeds, audio feeds, etc.) are received, a subscription servicing module 260 provides the events or information to any subscribers (e.g., subscriber devices 265, subscriber services 270, subscriber agents 275, subscriber LSS's or LSP's 280, etc.). It is then up to individual subscribers to interpret those events, take action and optionally re-publish new events, which could be picked up by other subscribers, processed, and/or acted upon, and/or re-published as new high-order events, etc.

2.0 Operational Details of the Logical Sensor Server:

The above-described program modules are employed for implementing various embodiments of the LSS. As summarized above, the LSS provides various techniques that allow messages received from different input sources to be authored, transformed and made available to one or more subscribers in a manner that allows intelligent event-driven behavior to emerge from a collection of relatively simple unrelated input sources. The following sections provide a detailed discussion of the operation of various embodiments of the LSS, and of exemplary methods for implementing the program modules described in Section 1 with respect to FIG. 1 and FIG. 2. In particular, the following sections provides examples and operational details of various embodiments of the LSS, including:

an operational overview of the LSS;

input sources and subscribers;

translating publications from input sources for subscribers;

optional event confidence levels;

security considerations;

ad-hoc groups of LSS's for sharing and enhancing data;

augmenting LSS performance obtaining one or more downloadable apps; and

implementing the LSS as a component within a logical sensor platform (LSP).

2.1 Operational Overview:

Developing solutions that derive event-driven behavior from the raw measurements of physical sensors typically means that those raw measurements are first processed and filtered to determine optimal actions. Such processing is usually application-specific and custom algorithms (limited to work with predetermined set of sensors) are generally not shared between otherwise unrelated applications.

For example, a typical home thermostat may poll temperature and, taking into account various user preferences and internal calendar/clock settings, turn a climate control system on or off. However, relying only on temperature sensors and internal calendar/clock settings does not take advantage of alternative sources of relevant information that may be useful to ensure that the climate control system remains off, or at some alternate setting. For example, various unrelated systems, such as a home security system, may ‘know’ whether someone is at home. This information, if fed into the thermostat or to the climate control system, could potentially save more energy by limiting use of the climate control system to times when people are in the home.

Advantageously, the LSS addresses such issues by allowing the thermostat, the climate control system, and/or the home security system to publish their readings and any other ‘actionable events’ based on those readings (e.g., Thermostat: “too cold” or “too hot”; Security System: “no one in house”) to the LSS. The thermostat, climate control system, and/or the home security system or other systems can then subscribe to higher-order events from LSS, and take actions based on any events they receive (e.g., climate control system overrides response to thermostat if a “no one in house” type event has been received in response to a subscription). Interestingly, any particular translated event (i.e., output events) can be used to spawn or trigger further translated events, thereby allowing the LSS to present events to subscribers for enabling complex control behaviors.

Further, as new devices with new capabilities to detect human presence or temperature are added to the list of publishers to the LSS, no modifications to the thermostat or the climate control system are necessary. For example, user operation of a TV remote control on a net-connected TV would result in a publication by the TV to the LSS of an indication that the TV was actively being used. In response, the LSS would transform this use indication to an event such as “people in house” that would then be provided to any subscribers (e.g., thermostat, climate control system, security system, etc.) interested in that type of event. Note that the “people in house” event may be formatted differently for any different subscriber subscribing to that particular event.

Advantageously, such capabilities allow the LSS to make simple technology appear ‘smart’, thereby enabling an effective human-technology interaction experience. In general, the LSS allows existing infrastructure to be used to aid in making complex event determinations for use by other systems. For example, determining if someone is on the floor of a building can be accomplished by evaluating coffee machine buttons, landline telephone use, elevator buttons, etc. However, creating a solution that requires wiring all of those sources to something like a light control system would likely be cost-prohibitive. Instead, the LSS provides a mechanism that allows those devices to publish and subscribe to a centralized authority, that receives, translates or transforms, and shares information between otherwise unrelated devices, systems, agents, etc., with new physical or logical (i.e., software-based) sensors, devices, etc., being added to the system without modifying any other sensors, devices, etc., coupled to the LSS.

Further, in order to reduce complexity, in various embodiments, the LSS itself plays no part in interpreting events, and instead simply collects and transforms events (or sensor readings) of one type into another based on static semantic rules. For example, an ‘Elevator Button Pushed’ event or publication can be transformed by the LSS into events such as ‘human detected in lobby’, ‘human detected on floor X’, ‘human in building’, etc., and sent to all apps, devices, control systems, etc., that subscribe to any of those events. It is then up to individual subscribers to interpret those events, take action and optionally re-publish new events, which could be picked up by other subscribers, processed, and/or acted upon, and/or re-published as new high-order events, etc. For example, consider the following exemplary sequence:
1. A thermometer sensor publishes temperature data to LSS;
2. A temperature change velocity software agent is subscribed to receive temperature data from the LSS, and publishes the speed at which temperature decreases or increases to the LSS (note the example of a publication by an agent in response to a receipt of a subscription to publications from an unrelated sensor);
3. A home thermostat is subscribed to receive both the temperature data and to the speed at which temperature decreases or increases from the LSS, and controls an HVAC unit depending not only on the absolute value of temperature, but also its change velocity.

In various embodiments, the LSS also includes, but is not limited to, logic to enable any combination of the following capabilities:
Duplicate/circular event transform detection and removal;
Synthetic (automatic or manual) event generation for troubleshooting and other purposes;
Modifying event data (e.g., changing quality of signal, such as low resolution image for some subscribers and high resolution images for other subscribers) based on security aspects (e.g., subscriber access level);
Syntax and logic for defining probability-based translations based on publications from sensors or events that offer signal confidence levels;
Registering new sensors with the LSS and defining transformations can be done by authorized agents (e.g., user interface, control panel app, etc.); and
Sensors and applications can define their own event types, and LSS rules can be set up to transform those new event types into events that have consumers (i.e., subscribers).

2.2 Input Sources and Subscribers:

As noted above, for purposes of explanation, the term “input source” in the following discussion is specifically defined as a device that detects or measures physical phenomena and quantities and transforms those into convenient electrical, radio frequency, audio or optical signals, that are then published as inputs or events to the LSS. Examples of input sources include, but are not limited to a wide variety of devices, sensors, voice input mechanisms, gesture or touch-based input mechanisms, software agents, software events, infrastructure events, etc.

Examples of devices include, but are not limited to, coffee makers, fans, phones, televisions, remote controls, appliances, etc. Examples of sensors include, but are not limited to motion sensors, temperature sensors, cameras, microphones, sensors embedded in consumer devices, etc. Examples of software events includes, but are not limited to, user activity on a computing device such as a tablet, netbook, notebook, desktop, media player, cell phone, or other form of computer, automatic actions or notifications on such devices, such as screen saver on or off, power save mode initiation or termination, email received, etc. Examples of infrastructure events include, but are not limited to, appliance use, pressing elevator buttons, flipping light switches, adjusting temperature controls, etc.

Further, as noted above, the term “subscriber” in the following discussion will generally be used when referring to a wide variety of devices, sensors, software agents, other LSS's or LSP's, etc., that receive higher-order events from the LSS that have been translated or transformed from the publications of one or more input sources. In addition, publishers may also be subscribers to information generated in response to input received by the LSS from other publishers. Further, subscribers may re-publish events or publish new events in response to events or information received from the LSS in response to publications from other publishers (or other subscribers).

In general, input sources provide one or more publications produced by those input sources to the LSS for translation or transformation and distribution to one or more subscribers. The LSS uses any of a variety of conventional techniques to receive the publications from the various input sources. Such techniques include, but are not limited to publications received via data messages or signals across various wired or wireless interfaces such as Ethernet, USB, FireWire®, Thunderbolt™, IEEE 802.x, RFID, etc. Further, existing devices without communications capabilities can be adapted to provide simple publications capabilities for use by the LSS. For example, a conventional current meter having wired or wireless networking capabilities can be plugged in line with the power cord of a device such as a lamp, coffee maker, exercise bike, etc., to publish an indication of when the device is in use based on power usage of the device.

Regardless of the communications protocols used, or whether a particular input source is augmented with communications capabilities, the general idea is that the input source simply reports information such as its current state (e.g., on or off, temperature reading, etc.), and/or events or other information generated by the input source. The types of events or other information generated by any input source clearly depends upon what that input source is, and what communications capabilities that input source may have. Examples include, but are not limited to, appliance power button pressed, motion detected by motion sensor, image stream from a video camera, etc.).

2.2.1 Logical Sensors:

Various devices that are not normally thought of as sensors can also act as valuable data sources (e.g., activation of coffee makers or pressing of elevator buttons acting as person sensors) for publication to the LSS. Deriving actionable events from such devices is not normally done due to cost associated with physical and logical wiring of those devices into existing decision-making agents. However, one of the many advantages of the LSS is that simply making the LSS aware of the input source and what an input or publication from that input source represents (e.g., pressing an elevator button indicates that a person is adjacent to the elevator button) allows that input source to publish to the LSS.

Further, devices containing sensors normally used for other purposes can be made to perform as logical sensors for use by the LSS via downloadable software apps or the like. For example, many modern cell phones contain sensors such as accelerometers, microphones, cameras, GPS, etc., and are capable of communicating readings from such sensors via WiFi or other wireless networking capabilities. Using simple apps designed for such purposes, any of the existing sensors in a cell phone can be turned on and used to collect data (e.g., audio, video, motion, location, etc.) with that data then being published to any one or more LSS's using various communications capabilities integral to the cell phone.

Physical sensor installation involves registering with the network via some, control panel or something that is or if it's all the episodes of the new apps that are designed to work with that sensor and essentially become the logical sensor for that physical stature that translate that census reading into something the LSP can absorb.

Similarly, software-based sensors represent software-based events that can be published to the LSS. For example, various operating systems are designed with activity-based indicators (e.g., screen savers, automatic power saving when not in use for some period, etc.). Apps that run under the operating system to capture and forward the initiation of such events create software-based sensors that can be used by the LSS as with any other input source. Other examples of apps for creating software-based sensors include apps the activate and monitor microphones, cameras, or other input means associated with a computing device to determine whether people are present, what those people may be doing, or other information depending upon the particular sensors being activated. Again, these apps can then capture and further process or forward the captured data for use by the LSS, as with any other input source.

Further, purely software-generated events can also be published to the LSS. Such capabilities enable a variety of scenarios such as allowing a user to control a subscribed lighting control system via an LSS connected computer without any additional infrastructure or lighting control system modifications.

In addition, in various embodiments, the LSS provides a mechanism wherein the output or publications of existing sensors or input devices is processed to enable the creation of new logical sensors and/or the initiation of actions not normally associated with the output or publications of the various sensors or input sources. For example, assume that there is no motion sensor in a user's home or that an existing motion sensor is offline for some reason (e.g., the battery for that sensor is dead). In response, the LSS can synthesize a logical motion sensor based on one or more of a wide range of publications from various input sources. For example, either or both a publication indicating usage of TV remote control or even a publication indicating a toilet flush inferred from flow rates through a water meter can be transformed into a “person in house” type output event that is then provided to one or more subscribers.

Further, in the machine-learning context, this enables the LSS to automatically synthesize and register new logical sensors based on observed correlations. For example, if toilet flush is always followed by triggering of a physical motion detector device, but that motion sensor suddenly stops reporting or triggering, then the LSS can still trigger a motion event (via automatic creation of a logical motion sensor, automatically registered as a publisher, that triggers based solely on the toilet flush). Advantageously, this also allows the LSS to ‘sense’ another physical phenomena, namely that the actual motion detector device may be malfunctioning. This ‘sensed’ physical phenomena can then be reported to the user or other service for further action (e.g., an alert to replace motion sensor battery, etc.).

2.2.2 Agents:

In general, software agents subscribed to the LSS perform or initiate various actuations (e.g., turn off lights and lower blinds) in response to information received from the LSS, such as a ‘TV turned on’ type event. Consequently, in contrast to typical sensor coupling, the LSS enables software agents to be coupled to data sensors that are logical in the sense that any particular software agent does not need to be physically coupled with a particular sensor. In other words, rather than being physically coupled to a sensor (or other input source), the agent is instead coupled to one or more particular types of events via a subscription to the LSS.

Further, the LSS allows an arbitrary number of input sources to publish information that can result in any of the events to which an agent is subscribed. These input sources can include physical sensors, intermediary software components that optionally process readings (e.g., noise filtering of raw data) prior to publication to the LSS, completely logical sensors that do not interact with the physical world for publishing information such as temperature, etc.

Consequently, the use of customizable software agents subscribed to the LSS allows those agents perform or initiate a wide variety of tasks or actions in response to events generated or triggered by the LSS in response to inputs or publications from other unrelated sensors, devices, etc. This allows the user to add or customize agents that are designed to perform or initiate particular tasks in response to specific types of events, and that are otherwise limited in scope and what they do. Advantageously, in various embodiments, the LSS can also be remotely updated by an administrator or other third-party source, such as, for example, a company that provides LSS-related services or support.

For example, in various embodiments, software agents can be designed to wait for receipt of a particular user-definable event provided via the LSS, and then send an analog or digital signal (e.g., logical ‘0’ or ‘1’) to a control device, such as, for example a simple network-based electronic switch or relay. Advantageously, this allows the use of agents in combination with simple network-based electronic switches or relays to turn other electronic devices on or off (by cycling power to those electronic devices) even where those electronic devices are not otherwise capable of being connected directly to the network or LSS.

2.3 Translations of Publications:

As noted above, the LSS receives publications from a variety of input sources and translates or transforms those publications into signals or events that are usable by one or more subscribers. For example, consider an IR-based TV remote control associated with a network connected TV and/or being monitored by a separate network connected receiver (e.g., network-based IR receiver). In this example, the LSS receives a publication indicating that an ‘on’ button of the remote control has been pressed and translates that publication into one or more events (e.g., ‘someone's in the living room’ type event). Consequently, this means that just the press of the TV remote button causes the LSS to fire a set of one or more predefined translations that may include translations or events based on custom coded HTML or XML scripts.

Advantageously, the TV remote control in the above example does not require any additional circuitry, intelligence, or capabilities. The network connected TV or IR receiver simply publishes the fact that a button was pushed to the LSS, and the LSS simply transforms that button press into one or more events for use by any other subscribers based on one or more sets of predefined or user-customizable translation rules.

For example, a lighting system that dims the lights when the TV is turned on does not know that it is indirectly responding to a TV remote control. Instead, the LSS includes one or more translation rules such as when the ‘on’ button of the TV remote control is pressed, that button press is transformed into a ‘somebody's in the room’ type event, and a ‘TV turned on’ type event. In this case, the lighting system can be subscribed to either or both the ‘somebody's in the room’ event and the ‘TV turned on’ event to trigger an new ‘dim lights’ type event or result in a lighting agent acting one way or another such as dimming the lights so the person can watch television. In other words, the LSS enables a soft translation from ‘somebody's in the room’ and ‘TV turned on’ to a ‘dim lights’ event that is consumed by the lighting system subscribed to the LSS.

In other words, given a device such as the TV remote control, for example, that device is registered or otherwise associated with the LSS such that the LSS understands and accepts publications from the device directly or via one or more intermediaries. In various embodiments of the LSS, the user is presented with a control panel or the like that allows the user to select or define translations for particular publications via a list, a wizard, by writing custom translation scripts, etc., in order to associate those publications with actions by various subscribers. A simple example is to use an optional LSS user interface to associate a TV remote control button press with some other action like dimming lights. A translation of the published button press into a format usable by a subscribed lighting control system then causes that system to dim the lights when the remote button is pressed.

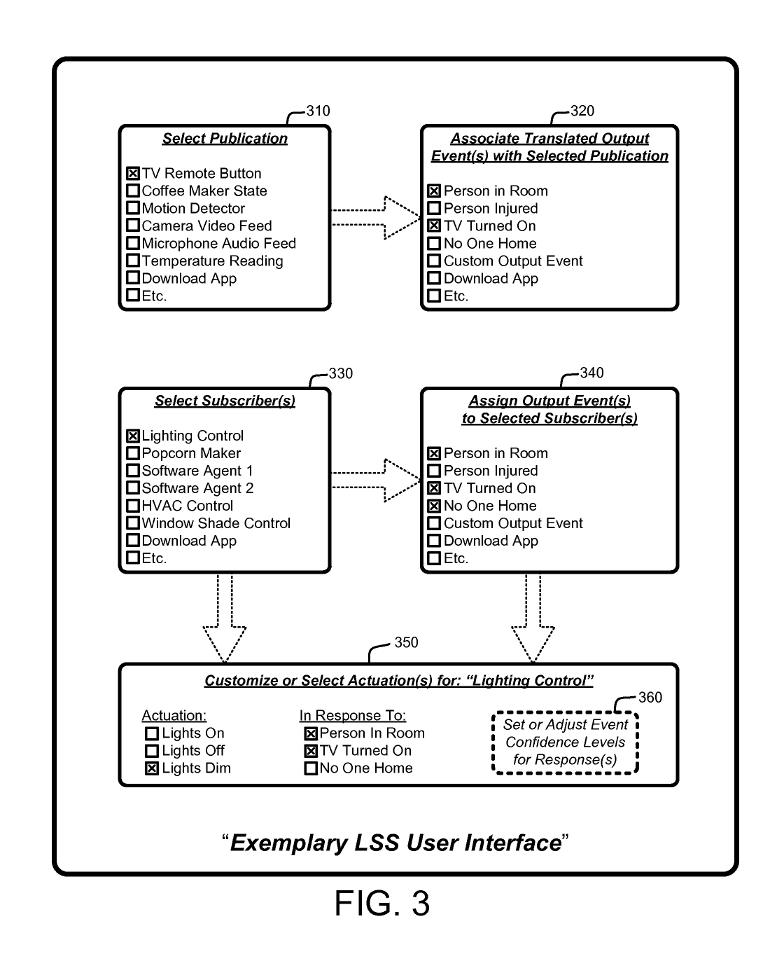

FIG. 3 illustrates a simple example of a control panel, wizard, or application for implementing an LSS user interface. As noted above, the LSS allows registration of input sources for publications (not shown in FIG. 3) and registration of subscribers for use with the LSS (not shown in FIG. 3). Thus, given the registrations of the input sources and subscribers, FIG. 3 illustrates user selection (310) of publications of the registered input sources and associating (320) the selected publication with one or more translated output events.

FIG. 3 also illustrates user selection (330) of particular subscribers and assignment (340) of one or more output events to selected subscribers. As such, whenever an output event is triggered by the LSS in response to the publication of any input source, the LSS will fire or transmit that output event to all subscribers to which that output event has been assigned. The exemplary user interface also illustrates customization (350) or selection of actuations to be performed or otherwise initiated by subscribers in response to receipt of particular output events.

Finally, the user interface of FIG. 3 also allows the user to set (360) or adjust confidence thresholds associated with one or more of output events for controlling actuations performed or otherwise initiated by selected subscribers. For example, assume that a video feed from a camera is evaluated by a software agent that then publishes a facial recognition result of “John Smith” to the LSS with a 70% confidence level. The LSS can then trigger an output event such as a ‘John Smith is in the Room’ type event along with that 70% confidence level. A subscribed music player that plays different music depending upon who is in the room will then initiate playback of the persons favorite songs as long as that playback is set to trigger whenever the person is identified with a confidence level of at least 70%.

Taking a closer look at FIG. 3, shows that FIG. 3 illustrates selection (310) of a “TV Remote Button” publication, with both a “Person in Room” output event and a “TV Turned On” output event being associated (320) and thus triggered by the LSS in response to a button being pressed on the TV remote control. Given these output events, the user can then select (330) one or more subscribers such as the “Lighting Control” subscriber as shown in FIG. 3.

Then, given the selection of the “Lighting Control” subscriber, the user can then assign (340) one or more of the available output events with that subscriber (e.g., “Person in Room”, “TV Turned On”, and “No One Home”). This ensures that, in this case, the “Lighting Control” subscriber will receive the assigned output events whenever any of those events are generated or triggered by the LSS in response to any publication from any input source.

Further, given that subscribers such as a lighting control system are typically capable of a variety of actuations (e.g., “Lights On”, “Lights Off′, or “Lights Dim” in this case), the user can then select any of those available actuations for the “Lighting “Control” and select which of the output events assigned to the “Lighting Control” will trigger particular actuations. For example, as illustrated by FIG. 3. The “Lighting Control” subscriber will initiate a “Lights Dim” actuation in response to receipt of both a “Person in Room” output event and a “TV Turned On” output event.

In view of the preceding examples, it should be clear that various embodiments of the LSS include options for allowing the user to assign or associate one or more available output events with various subscribers or actuators (e.g., lighting control systems, automated shades, sound systems, etc.), particular categories of available actuators, available actuators in particular rooms, buildings, or areas, etc. The user can then simply select what they would like any particular actuator to do in response to any particular publication.

2.3.1 Exemplary Script-Based Translation Formats:

As discussed above, the LSS transforms or translates publications to create output events and propagates those events to various subscribers. In various embodiments, the LSS preforms these transformations or translations using script-based scenarios (e.g., HTML, XML, etc.) that contain configuration information for determining transformations and propagation of output events to subscribers.

For example, the LSS may be configured to fire a ‘People detected on floor’ output event and a ‘People detected in building’ output event, when a ‘Motion Detected’ publication is received from a motion detection sensor. Subscribers such as floor and building light control systems may be subscribed to either or both the ‘People detected on floor’ and ‘People detected in building’ events. Consequently, those systems will be notified by the LSS with the ‘People detected on floor’ and ‘People detected in building’ events, whenever the ‘Motion Detected’ event is fired.

One example of expressing the above-described configuration is illustrated below by the script presented in Table 1. However, it should be understood that scripting for transforming publications and firing output events to subscribers is not intended to be limited to the script formats illustrated below, and that the scripts illustrated below are provided only for purposes of explanation and example.

TABLE 1
Exemplary Publication, Transformation and Subscription Script

<Event=“Motion Detected”>

<SpawnTransform> // Transform “Motion Detected” pub to output events

<Event=“People detected on floor”

Floor=“SensorRegistry.{Source.SensorID}.Floor}”>

<Event=“People detected in building”

Building=”{SensorRegistry.{Source.SensorID}.Building}>

<\SpawnTransform>

<\Event>
<Event=“People detected on floor”>

| | |
|---|---|
| <Subscribers> | // Fire output events to subscribers |

<Name=“Floor Lighting Control” URL= “...” PrivateKey=“...”>

<\Subscribers>

<\Event>
<Event=“People detected in building”>

| | |
|---|---|
| <Subscribers> | // Fire output events to subscribers |

<Name=“Building Lighting Control” URl=”...” PrivateKey=”...”>

<\Subscribers>

<\Event>

| | |
|---|---|
| <SensorRegistry> | // Published events or inputs from registered input sources |

<Sensor>

<SensorID=“123”>
<Event=“Motion Detected”>
<Name=“Motion sensor in the corner of the conf. room 2222”>
<Floor=“2”>
<Building=“115”>

<\Sensor>

<\SensorRegistry>

Then, continuing with the example of Table 1, if a new sensor or other publisher, such as a coffee machine, is added to the sensor registry, the LSS can be configured to also transform its publication into the ‘Motion Detected’ event, with that new ‘Motion Detected’ event then spawning other events and firing of those events to subscribers. This will have the same effect on the floor and building lighting system discussed above as did the dedicated motion detection sensor (i.e., “<SensorID=”123“>”). This new transform can be expressed by modifying the script of Table 1 to produce the script illustrated by Table 2:

TABLE 2
Exemplary Publication, Transformation and Subscription Script

<Event=“Coffee Ordered”> // Transform “Coffee Ordered” publication or event

<SpawnTransform>

<Event=“Motion Detected”>

<\SpawnTransform>

<\Event>
<Event=“Motion Detected”>

<SpawnTransform> // Transform “Motion Detected” publication or event

<Event=“People detected on floor”

Floor=“SensorRegistry.{Source.SensorID}.Floor}”>

<Event=“People detected in building”

Building=”{SensorRegistry.{Source.SensorID}.Building}>

<\SpawnTransform>

<\Event>
<Event=“People detected on floor”>

| | |
|---|---|
| <Subscribers> | // Fire output events to subscribers |

<Name=“Floor Lighting Control” URL= “...” PrivateKey=“...”>

<\Subscribers>

<\Event>
<Event=“People detected in building”>

| | |
|---|---|
| <Subscribers> | // Fire output events to subscribers |

<Name=“Building Lighting Control” URl=”...” PrivateKey=”...”>

<\Subscribers>

<\Event>

| | |
|---|---|
| <SensorRegistry> | // Published events or inputs from registered input sources |

<Sensor>

<SensorID=“123”>

<Event=“Motion Detected”>
<Name=“Motion sensor in the corner of the conf. room 2222”>
<Floor=“2”>
<Building=“115”>

<\SensorID=“123”>

<\Sensor>
<Sensor>

<SensorID=“456”>

<Event=“Coffee Ordered”>
<Name=“Coffee and Latte machine in the Kitchen”>
<Floor= “2”>
<Building= “115”>
<Size=“Tall”>

<\SensorID=“456”>

<\Sensor>

<\SensorRegistry>

Notice in Table 2 how the ‘Coffee Ordered’ event published by the coffee and latte machine does not transform directly into the higher order ‘People detected on floor’ event or to the ‘People detected in building’ event. Rather, this transformation takes two passes, where the ‘Coffee Ordered’ event is first transformed to the ‘Motion Detected’ event, which is in turn transformed to both the ‘People detected on floor’ and ‘People detected in building’ events. Advantageously, this type of multi-pass translation avoids duplication and keeps translation semantic tree size small.

The exemplary scripts provided above illustrate examples of relatively short and simple transformations. However, another advantage of allowing multi-pass translations is that such capabilities enable the construction of arbitrarily complex translation networks, where applications or subscribers receive events at one level of abstraction, take action in response to those received events, and then publish new events at other levels of abstraction in response to the actions taken in response to the original events. Such translation chains, referred to herein as “t-chains” facilitate arbitrarily high levels of event abstraction that can result in human-like levels of contextual awareness, resulting in output events such as ‘person fell asleep on couch’. Appropriate agents or subscribing systems sensitive to this output event can then trigger actuations such as, for example, lowering the volume of the TV, turning off the room lights, adjusting the room temperature, sending incoming telephone calls to voicemail, etc.

Advantageously, this type of higher level of contextual awareness is not a result of increased complexity at any given level, but rather an emergent behavior of the overall system provided by the LSS where each agent is specialized, simple and vertically isolated from agents at distant levels. Consequently, the LSS may grow significantly in size, adding more connections and nodes, as more agents register for publications and subscriptions, while remain logically simple and business logic-free.

Further refinements to the processes described above are enabled by using a translation syntax or format that allows confidence levels or thresholds to be specified to create rules for selective (property-based) transformation and propagation of events. For example, using confidence levels or thresholds, a ‘Motion Detected’ event from a motion detection sensor is transformed into a ‘People detected on floor’ event only if the confidence level is at or above a certain threshold. See Section 2.4 for additional discussion regarding event confidence levels.

2.3.2 Automated Translation Scenarios:

In addition to the user-centric embodiments of the LSS discussed above, in various embodiments, the LSS provides standard or pre-defined responses to particular inputs. For example, when a user turns on a television, other events are likely to be desired such as initiating a “movie watching mode” which would automatically turn off lights and close window shades.

More specifically, in various embodiments, pre-defined scenarios or scripts for responding to particular user actions can be automatically provided to the LSS (e.g., a local script library provided with the LSS, or downloadable apps, scripts, etc.). These pre-defined scenarios or scripts provide the LSS with instructions or rules for translating particular types of publications, and providing corresponding output events to particular types of subscribers so that those subscribers can initiate particular actions.

Advantageously, such pre-defined scripts or scenarios also allow the LSS to suggest particular hardware or software to the user in the event that the user does not have such hardware or software. For example, assume that the LSS makes use of a pre-defined script that automatically subscribes a control system (hardware and/or software) for closing window shades and that further subscribes a lighting control system for dimming lights in response to a publication and corresponding output event generated or triggered in response to turning on a television. If the user has a control system for dimming the lights but no control system for closing window shades, the LSS can suggest to the user sources for ordering and/or configuring a control system for closing window shades. In various embodiments, this also allows the LSS to push advertisements to the user for hardware and/or software control systems, actuators, installation services, etc., for improving the user experience with respect to usage of the LSS relative to specific actions and publications of the user's current configuration.

2.3.3 Automated Learning-Based Scenarios:

In general, automated learning techniques for evaluating user behaviors over time to elucidate user behaviors or patterns are known to those skilled in the art and will not be described herein. Advantageously, various embodiments of the LSS further adapt computer-learning techniques that evaluate user behavior over time to provide automatic configuration of various subscribers or actuators relative to one or more publications and corresponding output events.

For example, if the user repeatedly starts movie playback following dimming local lights and closing local window shades, the LSS can learn those actions over time using conventional learning techniques. Advantageously, the LSS can then automate those actions in any order. For example, if the user begins movie playback without first closing the blinds and dimming the lights, the LSS can trigger output events to agents or control systems associated with the blinds and lights to cause closing and dimming of the lights with no further action required by the user.

In other words, various embodiments of the LSS use computer-learning techniques to automatically associate or assign various publications to one or more translated output events. Those translated output events are then automatically passed to various subscribers for automating various system control scenarios without requiring direct user input. Note that in various embodiments, the user is provided with a user interface for adjusting or customizing any automated behaviors, subscriptions, translations of publications, etc.

More specifically, in various embodiments, the LSS automatically learns from user behaviors to determine translated output events to be assigned to particular publications, with those output events then being automatically fired to various types of subscribers. For example, when a user turns on a television, other events may then be manually initiated by the user, such as, for example, turning off or dimming lights and closing window shades. Assuming that the lighting control system and window shade control provide publications indicating the user actions to the LSS, the LSS can observe and record these actions, and then automatically repeat actions performed by the user following particular actions such as pressing the ‘on’ button for a TV remote control.

Advantageously, the LSS can learn from specific user behaviors or from behaviors of large sets of users (e.g., in optional embodiments where the user allows anonymous reports to the LSS of user behaviors and configurations of publishers and subscribers). This allows a wide variety of scenarios or programs to be pushed or otherwise provided to a user's LSS that can then be locally customized based on the user's preferences. Further, some or all of the hardware and software (i.e., publishers and subscribers) associated with the user's LSS may or may not relate to particular scenarios or programs provided to the user's LSS. However, as discussed above, the user can add, remove, configure, etc., publishers and subscribers to the LSS at any time. Advantageously, as noted above, in various embodiments, the LSS can push informational publications or advertisements to the user relating to hardware and/or software control systems, actuators, installation services, etc., for improving the user experience with respect to usage of the LSS relative to specific actions and publications of the user's current configuration.

2.4 Event Confidence Levels:

As noted above, in various embodiments, the LSS optionally sets or adjusts thresholds or confidence levels for probability-based translations based on publications from sensors or events that offer signal confidence levels (e.g., software agent returns a facial recognition with a 70% confidence of accuracy). Note that multiple publications having different confidence levels may also be combined or aggregated in any way desired to generate or trigger outputs having aggregate confidence levels. Such levels can then be used by subscribers in deciding whether to actuate or initiate particular actions.

In general, the LSS translates events based on binary events. For example, if the user pushes a remote control button to open a garage door, a binary event such as ‘garage door open’ can be triggered by the LSS. However, in the case that particular sensors (or combinations of sensors) or publishers are capable of providing a publication in combination with a corresponding probabilistic level of confidence that the publication is correct, the LSS can make use of this information for either triggering particular translations or for passing those confidence levels to subscribers for further action. For example, using motion sensors to decide whether somebody is sleeping, injured, or dead, would likely require different levels of confidence, and likely the input of other sensors (e.g., skeleton tracking using a Kinect® device and remotely measuring body temperature using an infrared temperature sensor).

Further, with respect to sensors such as motion detectors, other actions such as a moving fan can potentially trigger motion sensors when a person is not in the room. In such cases, a ‘person in room’ type event could be triggered with some relatively low confidence level when a motion sensor trips. In contrast, using an infrastructure event such a manual light switch being flipped or an elevator button being pressed could be used to trigger the ‘person in room’ type event with nearly 100% confidence since it is extremely unlikely that such events would happen without human intervention. As such, it should be clear that the same event could be triggered with different confidence levels in response to different publications.

Further, different confidence levels may be used to trigger particular events depending upon confidence levels associated with other publications or events. In other words, in various embodiments, the LSS allows different actions to be initiated at confidence levels associated with those actions anywhere from zero to 100% where the confidence is determined via some interpretation or analysis or input from the publications of one or more sensors. Advantageously, in various embodiments, the LSS monitors events over time to build models to derive confidence levels associated with particular publications or events, and can optionally test against those models to validate them.

2.5 Security Considerations:

In various embodiments, the LSS optionally ensures security and privacy of data collected by sensors and events published into the LSS by restricting any combination of publications, subscriptions, and events to authorized parties only (including authorized or verified users, authorized or verified publishers, and authorized or verified subscribers). Existing security protocols for ensuring that only trusted devices, users, subscribers, etc. are connected to the LSS are used. Further, untrusted publishers or subscribers may be allowed limited access to particular events or publications. In other words, in various embodiments, the LSS employ various security mechanisms to ensure that activating a sensor and publishing under the network and receiving subscriptions are all done in a secure and authorized manner.

Further, under various circumstances, untrusted publications from known or unknown sources may be accepted by the LSS. For example, an audio feed from an unknown microphone (e.g., microphone in the cell phone of an unknown nearby user) publishing approximately the same audio feed as a trusted microphone in a room can be combined with the trusted audio feed to generate an improved quality audio signal using conventional audio processing techniques. Similarly, ad-hoc groups of untrusted LSS's associated with other users may also be allowed to publish information to the LSS (e.g., multiple user's phones in a noisy room can all be used to capture audio data that can be significantly improved via conventional audio processing techniques as the number of audio streams is increased).

Consequently, it should be clear that in various embodiments, transformations of publications by the LSS can either augment sensor data or publications or degrade that sensor data or publications for various security reasons. Such augmentation or degradation is accomplished by using software agents between the publisher and the subscribers to modify the data in ways that will increase security or guarantee privacy in whatever manner is desired.

In addition, multiple different levels of security may also be provided. For example, an authorized user may be allowed to receive a high definition publication of a camera in the home, while a security guard sitting outside the house may only be allowed to receive a lower resolution version of the same camera view. Such embodiments are enabled by setting or determining the security level of subscribers to provide different access levels or different quality of service for sensor data or other publications provided in response to subscriptions at different access or security levels.

2.5.1 Anonymous Publications:

Advantageously, in various embodiments, the LSS simplifies the process of configuring the publication process by allowing anonymous publications. This allows publications without requiring the user to register particular input sources with the LSS. Further, depending upon the type of publication, the LSS can simply allow or reject anonymous publications. For example, assume that five people enter a room and begin a group discussion, and that each person allows microphones in their cell phone to capture and stream audio data of the conversation to one or more of those user's LSS's.

In such cases, the LSS can receive anonymous audio stream publications to create a composite and improved audio stream using conventional audio processing techniques with little or no security risk by receiving the anonymous publications. In contrast, security risks for subscribing to an LSS are likely to be greater. Consequently, in various embodiments, anonymous subscribers are either not allowed, or are granted limited or degraded access to output events or other information provided by the LSS.

Consequently, it should be clear that in various embodiments, the LSS can be configured at any level from wide open where anyone can subscribe or publish to the LSS. Further, the LSS can be configured to limit or restrict subscriptions and/or publications to one or more levels of authorized publishers, subscribers, or users.

2.6 Ad-Hoc Groups:

In addition to providing an LSS in a stationary environment (e.g., building, home, etc.), various embodiments of the LSS are implemented in mobile scenarios where that allow ad-hoc groups of publishers to be constructed or torn down whenever arbitrary sensors or other publishers become available or drop out. Further, in the mobile case where there are many publishers available that are publishing to the mobile LSS, the individual user or LSS can decide which of multiple publications, or types or categories of publications to accept or reject. Further, individual users can also decide whether to allow their LSS to publish or re-publish particular events or sensor data to other LSS's or other services. In addition, multiple LSS's can be connected to form interconnected groups or networks of LSS's that share some or all publications and subscriptions.

2.7 Apps:

Since any authorized entity can perform the role of a sensor or publisher, in various embodiments, the LSS provides access to an app store or marketplace or the like for virtual (software-based) logical sensors. Such apps can be distributed to and installed on any compatible platform (e.g., mobile phone, PC, embedded devices, etc.). Such apps, when connected to LSS, can offer additional sensing based on logic of those apps. For example, an app that is allowed to access accelerometers and/or GPS hardware on a user's cell phone can determine whether the users' mobile device (and thus the user) is ‘walking’, ‘driving’ or ‘stationary’.

Apps can be designed to provide any desired functionality, and may also include or represent custom translations or transformations of a variety of publications. In addition, various apps may be designed to work with particular hardware (e.g., a hardware mechanism for automating the opening and closing of window shades). Apps can be bundled with such hardware and obtained via the app marketplace or other sources.

Further, in various embodiments, the LSS, or a service associated with the LSS can automatically suggest particular apps to the user based on user actions. For example, say a user often watches movies. The LSS or service associated with the LSS can auto alert the user that other users that watch movies use the LSS (with associated subscribers and hardware actuators) to automatically dim the lights and close the window shades. The LSS or service associated with the LSS can then suggest or offer to the user apps and/or hardware (or professional installation services) that could be used to enhance the user's own system to enable the functionality of the other users that watch movies.

2.8 Logical Sensor Platform (LSP):

As described above, in various embodiments, the LSS manages publishing and subscriptions of the various devices, systems, agents, etc., in addition to the publication translations and transformations noted above. However, in related embodiments, the LSS simply handles publication translations and transformations as a sub-component of a “Logical Sensor Platform” (LSP). In other words, in various embodiments, the LSP provides an optional wrapper around the LSS that lifts some of the burden from the LSS by providing registration of publications and subscriptions and a user interface, thus allowing the LSS to simply receive and translate publications. In this case, the LSP provides a unified hardware-agnostic platform for publishing, subscribing, and transforming sensor data (via the LSS). In various embodiments, the LSP includes, but is not limited to, several basic building blocks, including:
an interface that defines a syntax for subscribing and publishing sensor data, application-defined information, higher-order events, etc.;
a registry service (or “aggregator”) that provides a software component that receives input from physical and logical sensors, devices, systems, agents, and other event publishers, and hosts the LSS logic; and
the aforementioned LSS that actually performs the translations and transformations of the publications received by the LSP.

As noted above, the LSP interface defines a syntax for subscribing and publishing sensor data, application-defined information, higher-order events, etc. The LSP interface is accessible for read/write to sensors, devices, systems, agents, and other event publishers/subscribers over secure or open protocols. Further, different sensors, devices, systems, agents, and other event publishers/subscribers can concurrently use different combinations of secure or open protocols.

The publishing syntax of the LSP interface enables specifying the type of the data (or event) being published, data and metadata associated with the event (such as sensor readings, timestamps, publisher ID, QOS, etc.), as well as additional rules that apply, such as expiry dates, degradation of quality based on time or access rights, etc. The subscription syntax of the interface defines parameters for registering for notifications (i.e., translated or transformed publications or higher-order events) based on their type or other conditions. Note that the interface may also define a query syntax for more sophisticated select statements (e.g., if both “Sensor A” and “Sensor B” publish particular sensor readings, then provide “Event C” to one or more particular subscribers.

The LSP registry service is a software component that receives input from physical and logical sensors, and hosts LSS logic. This registry service may support push- or pull-type notifications to subscribed parties, and offer parts or a whole of the connected sensors' latest state. Because any authorized party may register to be a publisher or subscriber, registry services may themselves act as sensors or subscribers, thus, when connected to each other, enabling composability, allowing specialization, aiding performance, re-transmission, etc.

Accessing the LSP registry service for read/write is optionally performed in a secure manner. Unauthorized sensors, subscriber agents or administrative applications are prevented from being able to publish or subscribe to events, or to view or modify the translation and transformation rules or scripts of the LSS. Eavesdropping on data flowing across sensor network (e.g., wireless snooping) is prevented in various embodiments using conventional security protocols including, but not limited to, claims-based authentication, SSL, encryption, etc.

3.0 Operational Summary of the Logical Sensor Server:

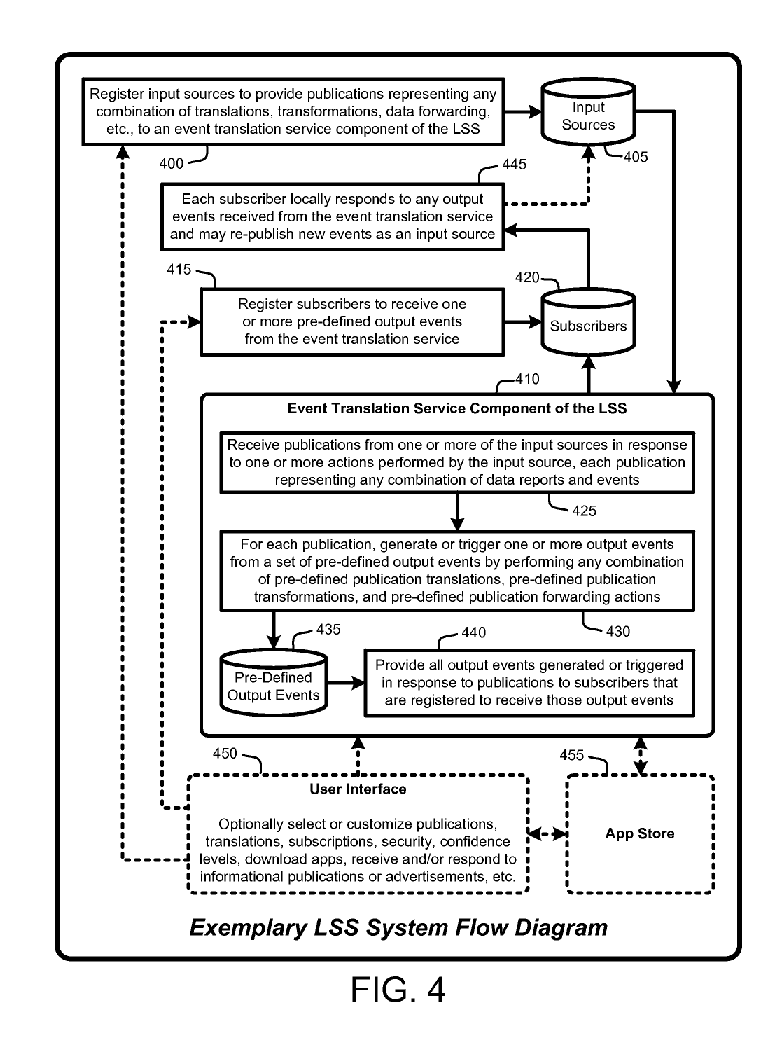

The processes described above with respect to FIG. 1 through FIG. 3 and in further view of the detailed description provided above in Sections 1 and 2 are illustrated by the general operational flow diagram of FIG. 4. In particular, FIG. 4 provides an exemplary operational flow diagram that summarizes the operation of some of the various embodiments of the LSS. Note that FIG. 4 is not intended to be an exhaustive representation of all of the various embodiments of the LSS described herein, and that the embodiments represented in FIG. 4 are provided only for purposes of explanation.

Further, it should be noted that any boxes and interconnections between boxes that may be represented by broken or dashed lines in FIG. 4 represent optional or alternate embodiments of the LSS, and that any or all of these optional or alternate embodiments may be used in combination with other embodiments of the LSS described throughout this document.

In general, as illustrated by FIG. 4, the LSS begins operation by registering (400) one or more input sources (405) to provide publications representing any combination of translations, transformations, data forwarding, etc., to an event translation service (410) component of the LSS. In addition, one or more subscribers (420) are registered (415) to receive one or more pre-defined output events (435) from the event translation service (410).

The event translation service 410 then receives (425) any publications representing any combination of data reports and events that are generated by any of the input sources (405) in response to any “actions” performed by the input source. In general, in view of the preceding discussion, it should be clear that “actions” performed by input sources include capturing sensor data (e.g., temperature, video data, audio data, etc.), triggering events in response to sensor operation (e.g., ‘motion detected’ event by a motion sensor), triggering infrastructure events (e.g., ‘elevator button pressed’), generating logical events using software agents, apps, or the like, etc.

In response to each publication received by the event translation service (410), the LSS then generates (430) or triggers one or more of the output events from a set of pre-defined output events (435) by performing any combination of pre-defined publication translations, pre-defined publication transformations, and pre-defined publication forwarding actions (e.g., temperature reading from one sensor passed or forwarded to a subscribing device), as discussed above. Any output event generated by the event translation service (410) in response to any publication is then provided (440) to any subscribers that are registered to receive those particular output events. Each subscriber then locally responds (445) to any output events received from the event translation service (410) and optionally acts as another input source (405) to publish or re-publish new events generated or triggered in response to the output events received by the subscriber.

In addition, in various embodiments, an optional user interface (450) is provided for optionally registering input sources and subscribers (400 and 415), selecting or customizing publications of the input sources (405), translations performed by the event translation service (410), subscriptions to various pre-defined output events (435), setting security levels, setting or adjusting confidence levels, downloading apps, receiving and/or responding to informational publications or advertisements, etc. Further, as discussed above, an optional app store (455) or the like is provided to enable the LSS or the user to download and make use of virtual (software-based) logical sensors, or various apps designed to work with particular hardware (e.g., a hardware mechanism for automating the opening and closing of window shades). Further, such apps can be bundled with hardware and obtained via the app marketplace or other sources.

4.0 Exemplary Operating Environments:

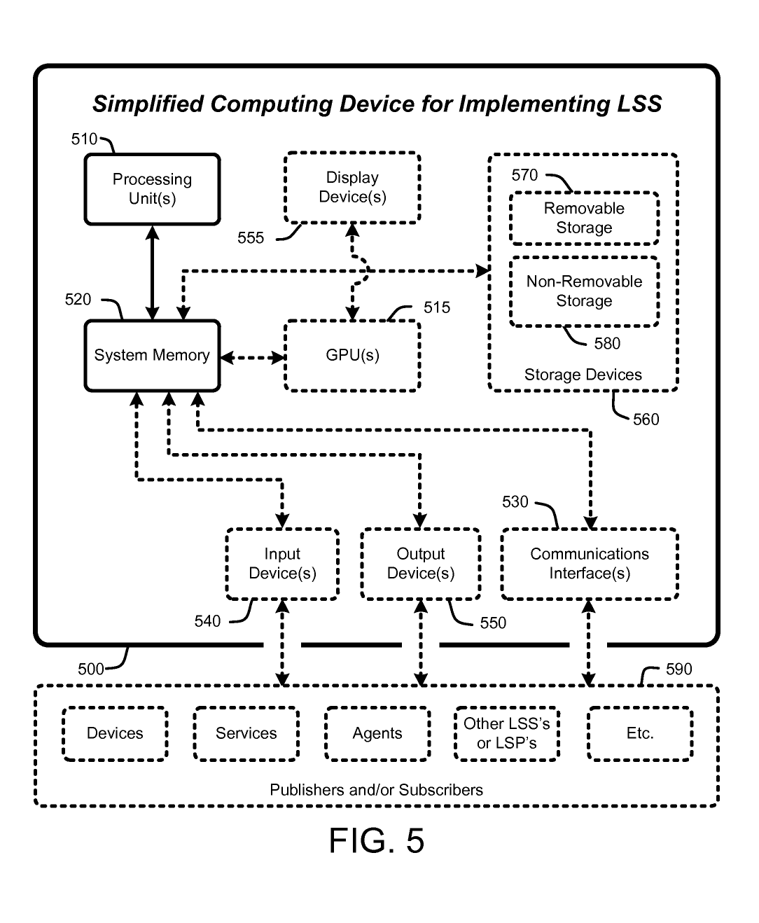

The LSS described herein is operational within numerous types of general purpose or special purpose computing system environments or configurations. FIG. 5 illustrates a simplified example of a general-purpose computer system on which various embodiments and elements of the LSS, as described herein, may be implemented. It should be noted that any boxes that are represented by broken or dashed lines in FIG. 5 represent alternate embodiments of the simplified computing device, and that any or all of these alternate embodiments, as described below, may be used in combination with other alternate embodiments that are described throughout this document.

For example, FIG. 5 shows a general system diagram showing a simplified computing device 500 in communication with various publishers and/or subscribers 590. Such computing devices can be typically be found in devices having at least some minimum computational capability, including, but not limited to, personal computers, server computers, hand-held computing devices, laptop or mobile computers, tablets, communications devices such as cell phones and PDA's, multiprocessor systems, microprocessor-based systems, set top boxes, programmable consumer electronics, network PCs, minicomputers, mainframe computers, audio or video media players, etc.

Computing devices suitable for implementing the LSS include devices having a sufficient computational capability and system memory to enable basic computational operations. In particular, as illustrated by FIG. 5, the computational capability is generally illustrated by one or more processing unit(s) 510, and optionally includes one or more GPUs 515, either or both in communication with system memory 520. Note that that the processing unit(s) 510 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 5 may also include other components, such as, for example, a communications interface 530. The simplified computing device of FIG. 5 may also include one or more conventional computer input devices 540 (e.g., pointing devices, keyboards, audio input devices, video input devices, haptic input devices, devices for receiving wired or wireless data transmissions, etc.). The simplified computing device of FIG. 5 may also include other optional components, such as, for example, one or more conventional computer output devices 550 (e.g., display device(s) 555, audio output devices, video output devices, devices for transmitting wired or wireless data transmissions, etc.). Note that typical communications interfaces 530, input devices 540, output devices 550, and storage devices 560 for general-purpose computers are well known to those skilled in the art, and will not be described in detail herein.

The simplified computing device of FIG. 5 may also include a variety of computer readable media. Computer readable media can be any available media that can be accessed by computing device 500 via storage devices 560 and includes both volatile and nonvolatile media that is either removable 570 and/or non-removable 580, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the LSS described herein, or portions thereof, may be stored, received, transmitted, or read from any desired combination of computer or machine readable media or storage devices and communication media in the form of computer executable instructions or other data structures.

Finally, the LSS described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

The foregoing description of the LSS has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the LSS. It is intended that the scope of the invention be limited not by this detailed description, but rather by the claims appended hereto.

What is claimed is:

1. A computer-implemented process for translating and sharing event data, comprising using a computing device to perform process actions for:
registering a plurality of input sources for publishing to a translation service;
registering a plurality of subscribers to receive one or more pre-defined output events from the translation service;
wherein one or more of the registered input sources provides one or more publications to the translation service in response to one or more actions performed by the input source, each publication representing any combination of data reports and events;
for any publication received by the translation service, triggering one or more of the output events by performing any combination of pre-defined publication translations, pre-defined publication transformations, and pre-defined publication forwarding actions; and
whenever the translation service triggers any output event, providing that output event to any subscriber registered to receive that output event.

2. The computer-implemented process of claim 1 wherein each subscriber locally responds to any received output event.

3. The computer-implemented process of claim 1 wherein one or more of the input sources is a logical sensor in the form of a software-based app.

4. The computer-implemented process of claim 1 wherein one or more of the input sources provides a confidence level in combination with one or more publications of that input source.

5. The computer-implemented process of claim 4 wherein one or more of the output events are triggered based on the confidence level of one or more corresponding publications.

6. The computer-implemented process of claim 1 further comprising process actions for registering one or more of the subscribers as input sources.

7. The computer-implemented process of claim 6 wherein one or more of the subscribers registered as input sources provide new publications to the translation service in response to one or more of the output events provided to those subscribers.

8. The computer-implemented process of claim 1 further comprising process actions displaying a user interface for registering one or more of the input sources and subscribers.

9. A system for translating and distributing event data, comprising:
a device for registering one or more input sources to provide publications representing any combination of translations, transformations, and data forwarding to an event translation device;
a device for registering one or more subscribers to receive one or more pre-defined output events from the event translation device;
using the event translation device to trigger one or more of output events from the set of pre-defined output events using any combination of pre-defined publication translations, pre-defined publication transformations, and pre-defined publication forwarding actions, in response to any publications received from any registered input source; and
a device for providing any output event triggered by the event translation device to any subscribers that are registered to receive those particular output events.

10. The system of claim 9 wherein each subscriber locally responds to any output events received from the event translation device.

11. The system of claim 10 wherein one or more of the input sources is a logical sensor in the form of a software-based app.

12. The system of claim 10 wherein:
one or more of the input sources provides a confidence level in combination with one or more publications of that input source; and
wherein one or more of the output events are triggered based on the confidence level of one or more corresponding publications.

13. The system of claim 10 further comprising registering one or more of the subscribers as input sources and wherein one or more of the subscribers registered as input sources provide new publications to the event translation device in response to one or more of the output events provided to those subscribers.

14. A computer-readable medium having computer executable instructions stored therein for sharing information, said instructions causing a computing device to execute a method comprising:
registering one or more input sources to provide publications representing any combination of translations, transformations, and data forwarding to an event translation service;
registering one or more subscribers to receive one or more pre-defined output events from the event translation service;
using the event translation service to trigger one or more of output events from the set of pre-defined output events using any combination of pre-defined publication translations, pre-defined publication transformations, and pre-defined publication forwarding actions, in response to any publications received from any registered input source;
providing any output event triggered by the event translation service to any subscribers that are registered to receive those particular output events; and
allowing each subscriber to locally respond to any output events received from the event translation service.

15. The computer-readable medium of claim 14 further comprising instructions for registering one or more of the subscribers as input sources.

16. The computer-readable medium of claim 15 wherein one or more of the subscribers registered as input sources provide new publications to the event translation service in response to one or more of the output events provided to those subscribers.

17. The computer-readable medium of claim 14 further comprising instructions for displaying a user interface for registering one or more of the input sources and subscribers.

18. The computer-readable medium of claim 17 further comprising accessing an app store via the user interface for obtaining one or more software-based logical sensors.

19. The computer-readable medium of claim 14 wherein:
one or more of the input sources provides a confidence level in combination with one or more publications of that input source; and
wherein one or more of the output events are triggered based on the confidence level of one or more corresponding publications.

20. The computer-readable medium of claim 19 further comprising a user interface for adjusting thresholds levels for triggering output events based on the confidence level of one or more corresponding publications.
